(19) United States
(12) Patent Application Publication
(10) Pub. No.: US 2015/0064297 A1
(43) Pub. Date: Mar. 5, 2015

(54) EXTRUDER HAVING A VACUUM FEEDER

(71) Applicant: Ko Win Yang Industrial Co., Ltd, Taichung City (TW)

(72) Inventor: Mu-Tsang YANG, Taichung City (TW)

(73) Assignee: Ko Win Yang Industrial Co., Ltd, Taichung City (TW)

(21) Appl. No.: 14/014,866

(22) Filed: Aug. 30, 2013

(51) Int. Cl. B29C 47/76; B29C 47/38

(52) U.S. Cl. CPC B29C 47/761; B29C 47/385
USPC 425/145; 425/209

(57) ABSTRACT

An extruder includes a machine base, a cylinder connected with one end thereof to the machine base and defining a feeding section adjacent to the machine base, a feed port at the feeding section and a discharge port at an opposite end, a screw pivotally connected with one end thereof to the machine base and accommodated in the cylinder and rotatable in the cylinder by an external force, a feed tank having a top through hole and a bottom through hole and connected to the feed port of the cylinder, a control valve mounted in the top through hole and operable to open or close the feed tank, and a vacuum pump connected to the feeding section of the cylinder through a piping and operable to pump air out of the feeding section and to further leave a vacuum in the feeding section.

### BACKGROUND OF THE INVENTION

1. Field of the Invention

The present invention relates to extrusion technology, and more particularly to an extruder equipped with a vacuum feeder.

2. Description of the Related Art

In most conventional extruders, the screw generally defines a feeding section, a mixing section, and a discharging section. In some extruders, one or two exhaust holes are made in the mixing section of the screw for discharging water from the applied plastic material. Waste plastic materials such as waste plastic bags or waste plastic films may carry a certain amount of water after washing. Even treated through dehydration and drying processes, residual water left among waste plastic bags or films still cannot be completely dried out. In consequently, a large amount of water vapor will be produced during the melt-mixing process. This water vapor can be mixed in the molten plastic material. Although exhaust holes are provided for exhaust of water vapor, this arrangement cannot guarantee that water vapor can be completely dried out. This is the major drawback of conventional extruders.

### SUMMARY OF THE INVENTION

The present invention has been accomplished under the circumstances in view. It is the main object of the present invention to provide an extruder having a vacuum feeder, which effectively reduces the residual water contained in the applied material.

It is another object of the present invention to provide an extruder having a vacuum feeder, which makes the feed more smoothly.

To achieve these and other objects of the present invention, an extruder having a vacuum feeder of the present invention comprises a machine base, a cylinder shaped like a long tube and connected with one end thereof to the machine base and defining a feeding section adjacent to the machine base, a feed port at the feeding section and a discharge port at an opposite end thereof, a screw pivotally connected with one end thereof to the machine base and accommodated in the cylinder and rotatable in the cylinder by an external force, a feed tank having a top through hole located at a top side thereof and a bottom through hole located at a bottom side thereof and connected to the feed port of the cylinder, a control valve mounted in the top through hole of the feed tank and operable to open or close the feed tank, and a vacuum pump connected to the feeding section of the cylinder through a piping and operable to pump air out of the feeding section and to further leave a vacuum in the feeding section.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic structural view of an extruder having a vacuum feeder in accordance with a first embodiment of the present invention.

FIG. 2 is a front view of an extruder having a vacuum feeder in accordance with a first embodiment of the present invention.

FIG. 3 is a top view of the extruder in accordance with the second embodiment of the present invention.

FIG. 4 is a schematic structural view of the extruder in accordance with the second embodiment of the present invention.

FIG. 5 is a horizontal sectional view of a part of the second embodiment of the present invention, illustrating the structure of the bearing block and the feeding section of the cylinder.

FIG. 6 is a sectional view taken along line 6-6 of FIG. 2.

### DETAILED DESCRIPTION OF THE INVENTION

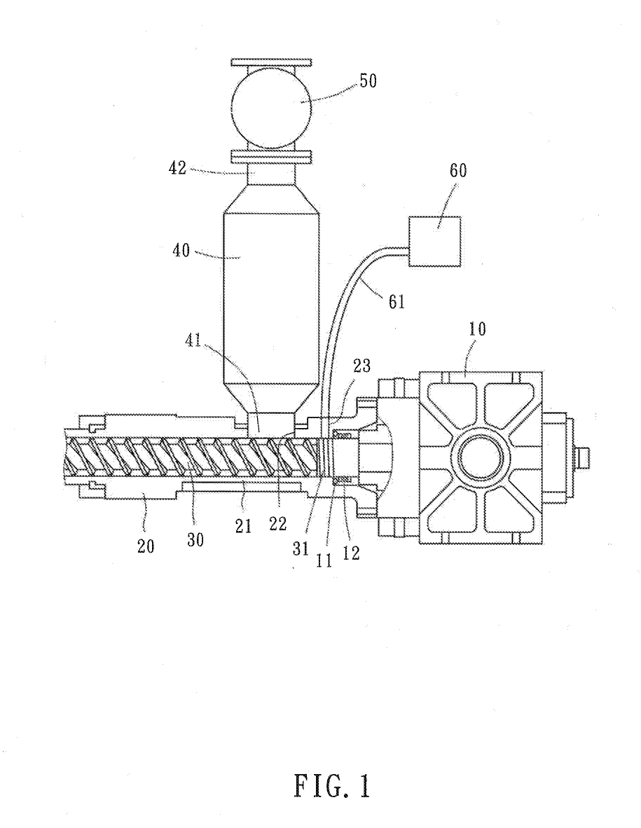

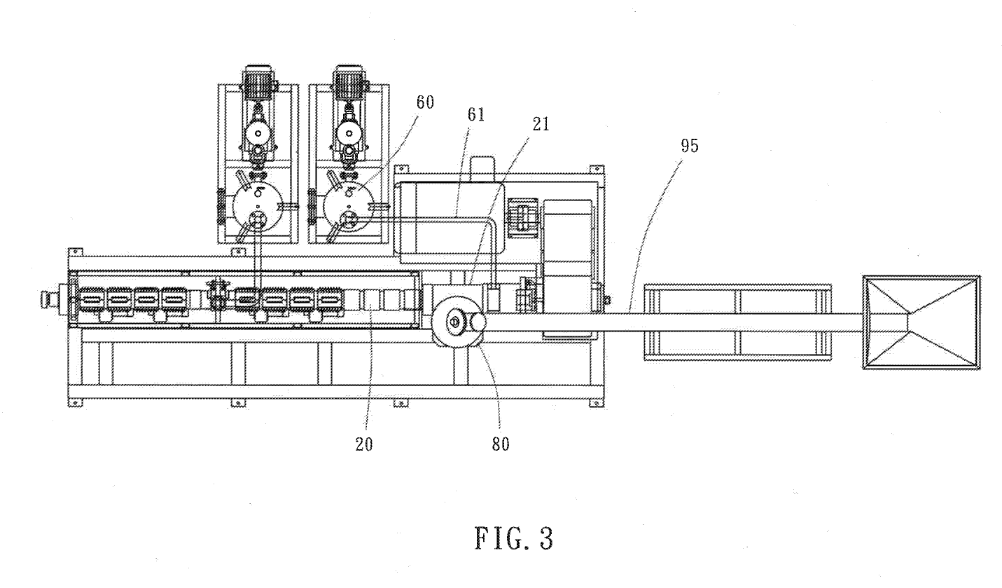

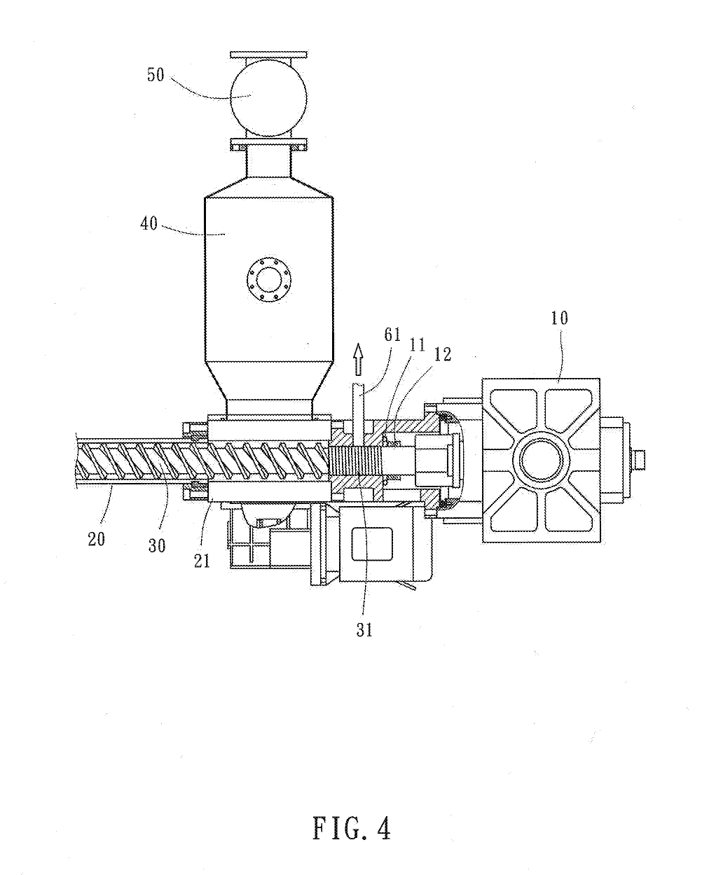

Referring to FIG. 1-4, an extruder having a vacuum feeder in accordance with a first embodiment of the present invention is shown. This first embodiment is a natural gravity feed type design, comprising:

a machine base 10;

a cylinder 20 shaped like a long tube and connected with one end thereof to the machine base 10, and defining a feeding section 21 adjacent to the machine base 10, a feed port 22 at the feeding section 21, and a discharge port (not shown) at an opposite end thereof;

a screw 30 pivotally connected with one end thereof to the machine base 10 and accommodated in the cylinder 20 and rotatable in the cylinder 20 by an external force;

a feed tank 40 having a top through hole 42 located at a top side thereof and a bottom through hole 41 located at a bottom side thereof and connected to the feed port 22 of the cylinder 20;

a control valve 50 mounted in the top through hole 42 at the top side of the feed tank 40 and operable to open or close the feed tank 40; and

a vacuum pump 60 connected to the feeding section 21 of the cylinder 20 through a piping 61 and operable to pump air out of the feeding section 21 and to further leave a vacuum in the feeding section 21.

Further, the screw 30 comprises a grooved area 31 pivotally coupled to the machine base 10 adjacent to the cylinder 20. The cylinder 20 further comprises a through hole 23 corresponding to the grooved area 31. The vacuum pump 60 is connected to the through hole 23 of the cylinder 20 by the piping 61, and kept in communication with the feeding section 21 of the cylinder 20 through the gaps in the pivot connection area between the screw 30 and the machine base 10. An O-ring 11 and a V-shaped gasket ring 12 are mounted in the connection area between the machine base 10 and the screw 30 to prevent leakage. Further, the machine base 10 has a gear train (not shown) mounted therein and drivable by a motor (not shown) to rotate the screw 30.

In this embodiment, a storage hopper or feed piping can be connected to the top side of the control valve 50. When in use, open the control valve 50 to let the prepared material fall into the feed tank 40. When the material in the feed tank 40 reaches a predetermined elevation, the control valve 50 is turned off automatically. At this time, the vacuum pump 60 keeps pumping, enabling the material to fall to the inside of the feeding section 21 of the cylinder 20 automatically subject to the double action of the force of gravity and vacuum suction. Further, the vacuum effect enables the water contained in the material in the feed tank 40 and the feeding section 21 to be evaporated easily, and the generated water vapor can also be drawn out by vacuum, thereby lowering the moisture content of the material to further improve the speed and quality of the production.

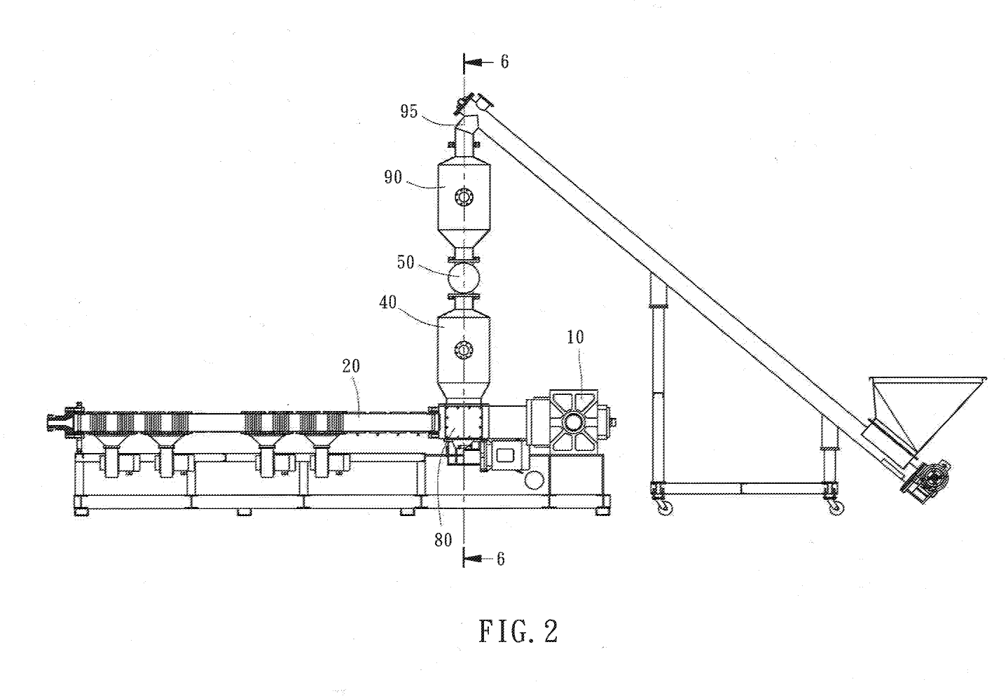

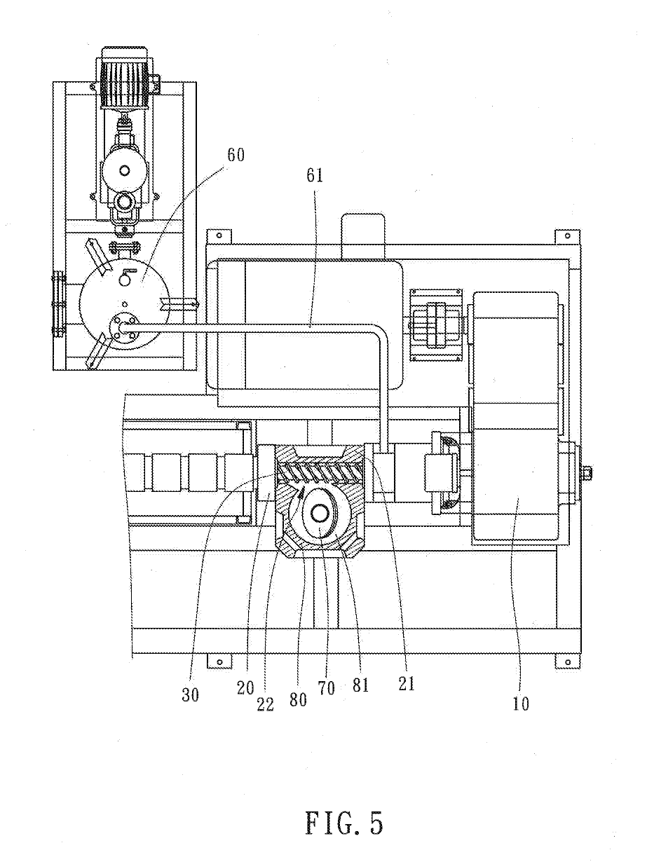

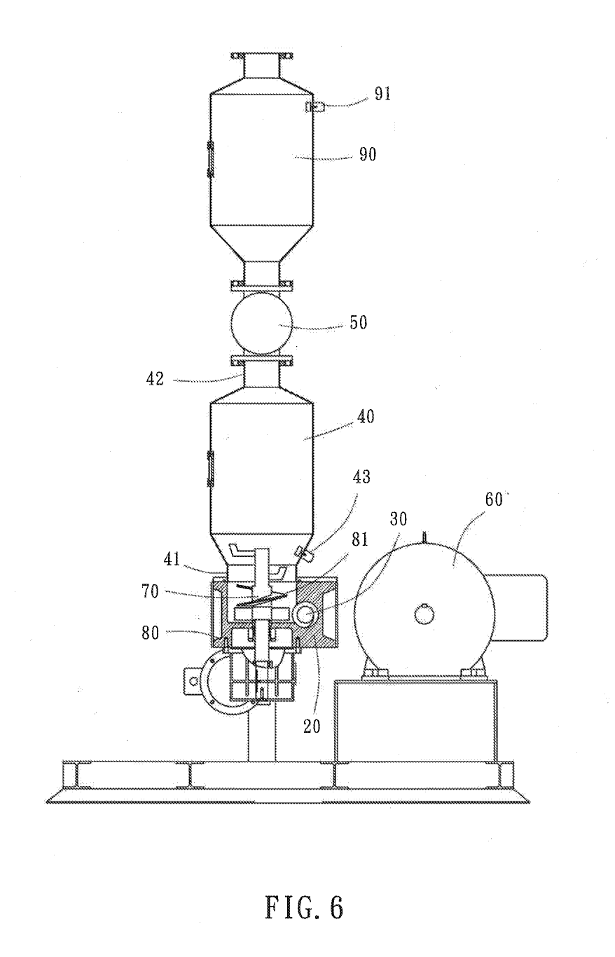

FIGS. 2-6 illustrate an extruder having a vacuum feeder in accordance with a second embodiment. To facilitate explanation, like reference signs designate like components throughout the specification. The extruder in accordance with this second embodiment also comprises a machine base 10, a cylinder 20, a screw 30, a feed tank 40, a control valve 50, and a vacuum pump 60. The structures of these components and their relationship are same as the aforesaid first embodiment. The cylinder 20 also comprises a feeding section 21 and a feed port 22. The screw 30 also comprises a grooved area 31. The cylinder 20 also comprises a through hole 23 corresponding to the grooved area 31 of the screw 30. The vacuum pump 60 is also connected to the through hole 23 by a piping 61. The major characteristics of this second embodiment are outlined hereinafter.

A force feed screw 70 is mounted within the feed tank 40, and adapted to propel the applied material into the feeding section 21 of the cylinder 20. The feeding section 21 of the cylinder 20 is equipped with a bearing block 80 at one lateral side thereof for the connection of the force feed screw 70 pivotally. The feed tank 40 is mounted on the bearing block 80. The bearing block 80 defines therein an accommodation chamber 81. The accommodation chamber 81 is kept in communication with the feed port 22 of the cylinder 20, i.e., the feed port 22 is disposed at one lateral side relative to the cylinder 20. A storage tank 90 is provided at the top side of the control valve 50. A feed piping 95 is connected to the top side of the storage tank 90. Further, a sensor 43 is mounted at the bottom side of the feed tank 40 for upper-limit material level detection, and a sensor 91 is mounted in a top side in the storage tank 90 for lower-limit material level detection. Thus, when the level of the supplied material in the feed tank 40 drops the sensing level of the upper level sensor 43, the control valve 50 is turned on automatically. After a predetermined set time, the storage material in the storage tank 90 automatically falls to the inside of the feed tank 40. Thereafter, the control valve 50 is automatically turned off to close the feed tank 40, and at the same time, the feed piping 95 is opened for enabling the prepared material to be delivered into the inside of the storage tank 90. After the material in the storage tank 90 reaches the sensing level of the lower level sensor 91, the feed piping 95 is closed automatically. Subject to the functioning of the vacuum pump 60, the water content in the material inside the feed tank 40 can be rapidly evaporated and drawn out, and thus, the applied material can be well dried, facilitating the subsequent processing operations and smoothening the material feeding.

What is claimed is:

1. An extruder, comprising:
a machine base;
a cylinder shaped like a long tube and connected with one end thereof to said machine base, said cylinder defining a feeding section adjacent to said machine base, a feed port at said feeding section, and a discharge port at an opposite end thereof;
a screw pivotally connected with one end thereof to said machine base and accommodated in said cylinder and rotatable in said cylinder by an external force;
a feed tank comprising atop through hole located at a top side thereof, and a bottom through hole located at a bottom side thereof and connected to said feed port of said cylinder;
a control valve mounted in said top through hole of said feed tank and operable to open or close said feed tank; and
a vacuum pump connected to said feeding section of said cylinder through a piping, said vacuum pump being operable to pump air out of said feeding section and to further leave a vacuum in said feeding section.

2. The extruder as claimed in claim 1, wherein said vacuum pump is kept in communication with said feeding section of said cylinder through gaps in between said screw and said machine base.

3. The extruder as claimed in claim 2, wherein said screw comprises a grooved area; said cylinder comprises a through hole corresponding to said grooved area of said screw; said vacuum pump is connected to the through hole of said cylinder by said piping.

4. The extruder as claimed in claim 1, further comprising a storage tank mounted at a top side of said control valve, and a feed piping connected to a stop side of said storage tank.

5. The extruder as claimed in claim 1, wherein said feed tank comprises a force feed screw mounted therein and adapted to propel a storage material out of said feed tank into said feeding section of said cylinder.

6. The extruder as claimed in claim 5, wherein said cylinder comprises a bearing block, located at one lateral side of said feeding section; said force feed screw is pivotally connected to said bearing block; said feed tank is mounted at said bearing block; said bearing block defines therein an accommodation chamber kept in communication with said feed port of said cylinder.

7. The extruder as claimed in claim 4, further comprising a sensor mounted at a bottom side of said feed tank for material level detection, and a sensor mounted in a top side in said storage tank for material level detection.

8. The extruder as claimed in claim 1, said machine base further comprising an O-ring and a V-shaped gasket ring mounted in between said machine base and said screw to prevent leakage.
